(19) United States
(12) Patent Application Publication
(10) Pub. No.: US 2025/0181050 A1
(43) Pub. Date: Jun. 5, 2025

(54) MACHINING SURFACE ESTIMATION DEVICE AND COMPUTER-READABLE STORAGE MEDIUM

(71) Applicant: FANUC CORPORATION, Yamanashi (JP)

(72) Inventor: Tomonobu SUZUKI, Yamanashi (JP)

(21) Appl. No.: 18/835,347

(22) PCT Filed: Feb. 22, 2022
(86) PCT No.: PCT/JP2022/007260

§ 371 Date: Feb. 19, 2025

(51) Int. Cl. G05B 19/401; G05B 19/4069

(52) U.S. Cl. CPC G05B 19/401; G05B 19/4069

(57) ABSTRACT

This machining surface estimation device comprises: an acquisition unit that acquires tool position data indicating the position of a tool, tool shape data indicating the shape of the tool, workpiece shape data indicating the shape of a workpiece, and factor data indicating factors affecting the control of a control axis; an association unit that associates the tool position data with the factor data; a simulation unit that generates a machining model on the basis of the tool position data, tool shape data, and workpiece shape data acquired by the acquisition unit; and a display unit that displays factor information, indicating the factor data, on the machining model generated by the simulation unit, on the basis of the tool position data and the factor data associated by the association unit.

### TECHNICAL FIELD

The present disclosure relates to a machined surface estimation device and a computer-readable storage medium.

### BACKGROUND ART

A machining machine used to machine a workpiece is controlled based on a machining program. For example, a control axis of the machining machine is controlled according to a feed rate designated by the machining program. However, when each control axis is operated according to a command designated by the machining program, for example, each control axis may operate at excessive acceleration. As a result, there is a possibility that a machined surface of the workpiece may be adversely affected.

Thus, for example, a value such as allowable acceleration is set as a control parameter in a numerical controller that controls the machining machine. In this case, the numerical controller controls each control axis so as not to exceed the allowable acceleration set as the control parameter. In other words, the allowable acceleration set as the control parameter serves as a deceleration factor for each control axis.

Patent Document 1 discloses technology for displaying information indicating a deceleration factor that affects a feed rate of a control axis on a movement path of a tool. In other words, Patent Document 1 can be considered to disclose technology for displaying information indicating a factor that affects control of the control axis. By using this technology, an operator can estimate at which position on the movement path of the tool a factor that affects control of the control axis has occurred.

### CITATION LIST

### Patent Document

Patent Document 1: JP 2012-22404 A

### SUMMARY OF THE INVENTION

### Problem to be Solved by the Invention

However, even when information indicating the factor that affects control of the control axis is displayed on the movement path of the tool, it is difficult for the operator to estimate at which position on the machined surface of the workpiece is being machined when this factor has occurred. For example, when the workpiece is machined with a side cutting edge of an end mill, the movement path of the tool, in other words, a trajectory of a tip of the tool, is not positioned on the machined surface of the workpiece. For this reason, even when information indicating a factor that affects control of the control axis is displayed on the movement path of the tool, there is concern that the operator may not be able to estimate at which position on the machined surface is being machined when this factor has occurred.

Therefore, there is a need for technology that allows the operator to easily estimate at which position on the machined surface is being machined when a factor that affects control of the control axis is occurring.

### Means for Solving Problem

A machined surface estimation device includes an acquisition unit configured to acquire tool position data indicating a position of a tool, tool shape data indicating a shape of the tool, workpiece shape data indicating a shape of a workpiece, and factor data indicating a factor affecting control of a control axis, an association unit configured to associate the tool position data with the factor data, a simulation unit configured to generate a machining model based on the tool position data, the tool shape data, and the workpiece shape data acquired by the acquisition unit, and a display unit configured to display factor information indicating the factor data on the machining model generated by the simulation unit based on the tool position data and the factor data associated by the association unit.

A computer-readable storage medium configured to store instructions causing a computer to execute acquiring tool position data indicating a position of a tool, tool shape data indicating a shape of the tool, workpiece shape data indicating a shape of a workpiece, and factor data indicating a factor affecting control of a control axis, associating the tool position data with the factor data, generating a machining model based on the tool position data, the tool shape data, and the workpiece shape data acquired, and displaying factor information indicating the factor data on the generated machining model based on the tool position data and the factor data associated with each other.

### Effect of the Invention

According to an aspect of the disclosure, it is possible to allow an operator to easily estimate at which position on a machined surface is being machined when a factor that affects control of a control axis has occurred.

### BRIEF DESCRIPTION OF DRAWINGS

FIG. 1 is a block diagram illustrating an example of a hardware configuration of a machining machine;

FIG. 2 is a block diagram illustrating an example of functions of a machined surface estimation device;

FIG. 3 is a diagram illustrating an example of tool position data;

FIG. 4A is a diagram for describing a speed difference;

FIG. 4B is a diagram for describing a speed difference;

FIG. 5 is a diagram for describing an in-position check;

FIG. 6 is a diagram illustrating an example of factor data acquired by an acquisition unit;

FIG. 7 is a diagram illustrating the tool position data and the factor data;

FIG. 8 is a diagram for describing display of factor information;

FIG. 9 is a diagram illustrating a specific example of the factor information displayed on a machining model;

FIG. 10A is a diagram for describing display of path correction data;

FIG. 10B is a diagram for describing display of the path correction data;

FIG. 11 is a flowchart illustrating an example of processing executed by the machined surface estimation device;

FIG. 12 is a block diagram illustrating an example of functions of the machined surface estimation device including a reception unit;

FIG. 13 is a diagram illustrating an example of a display mode of the factor information;

FIG. 14 is a block diagram illustrating an example of functions of the machined surface estimation device; and

FIG. 15 is a diagram illustrating an example of machining information displayed on the machining model.

### MODE(S) FOR CARRYING OUT THE INVENTION

Hereinafter, a machined surface estimation device according to an embodiment of the disclosure will be described using the drawings. Note that not all combinations of features described in the embodiment below are necessary to solve the problem. Further, more detailed description than necessary may be omitted. Further, the following description of the embodiment and the drawings are provided to enable those skilled in the art to fully understand the disclosure, and are not intended to limit the scope of the claims.

The machined surface estimation device is a device that displays at which position on a machined surface a factor that affects control of a control axis occurs on a display screen of a display device. The machined surface estimation device generates a machining model indicating the machined surface, and displays information indicating a factor that affects control of the control axis on the machining model.

The machined surface estimation device is mounted, for example, in a numerical controller that controls a machining machine. The machined surface estimation device may be mounted in a server or a PC (Personal Computer) connected to the numerical controller. Hereinafter, a description will be given of the machined surface estimation device mounted in the numerical controller.

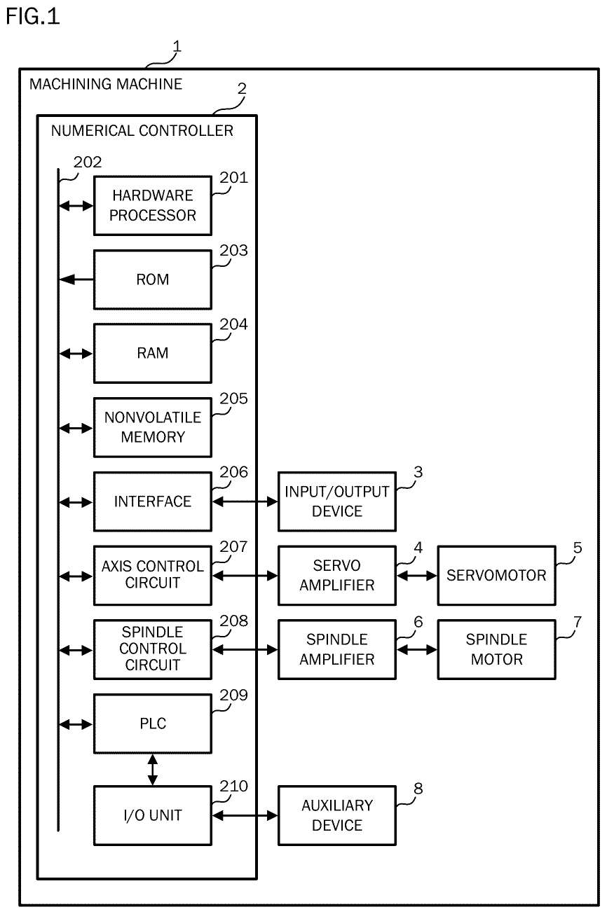

FIG. 1 is a block diagram illustrating an example of a hardware configuration of the machining machine including the numerical controller. The machining machine 1 includes a machine tool, a wire discharge machining machine, an injection molding machine, and a 3D printer. The machine tool includes a lathe, a machining center, and a complex machining machine.

The machining machine 1 includes a numerical controller 2, an input/output device 3, a servo amplifier 4, a servomotor 5, a spindle amplifier 6, a spindle motor 7, and an auxiliary device 8.

The numerical controller 2 is a device that controls the entire machining machine 1. The numerical controller 2 includes a hardware processor 201, a bus 202, a ROM (Read Only Memory) 203, a RAM (Random Access Memory) 204, and a nonvolatile memory 205.

The hardware processor 201 is a processor that controls the entire numerical controller 2 according to a system program. The hardware processor 201 reads a system program, etc. stored in the ROM 203 via the bus 202, and performs various processes based on the system program. The hardware processor 201 controls the servomotor 5 and the spindle motor 7 based on a machining program. The hardware processor 201 is, for example, a CPU (Central Processing Unit) or an electronic circuit.

For example, the hardware processor 201 analyzes the machining program and outputs control commands to the servomotor 5 and the spindle motor 7 every control cycle.

The bus 202 is a communication path that connects respective pieces of hardware in the numerical controller 2 to each other. The respective pieces of hardware in the numerical controller 2 exchange data via the bus 202.

The ROM 203 is a storage device that stores a system program, etc. for controlling the entire numerical controller 2. The ROM 203 may store a machined surface estimation program. The ROM 203 is a computer-readable storage medium.

The RAM 204 is a storage device that temporarily stores various data. The RAM 204 functions as a work area for the hardware processor 201 to process various data.

The nonvolatile memory 205 is a storage device that retains data even in a state in which the machining machine 1 is powered off and the numerical controller 2 is not supplied with power. The nonvolatile memory 205 stores, for example, a machining program and various parameters. The nonvolatile memory 205 is a computer-readable storage medium. The nonvolatile memory 205 includes, for example, a memory backed up with a battery or an SSD (Solid State Drive).

The numerical controller 2 further includes an interface 206, an axis control circuit 207, a spindle control circuit 208, a PLC (Programmable Logic Controller) 209, and an I/O unit 210.

The interface 206 connects the bus 202 and the input/output device 3 to each other. For example, the interface 206 transmits various data processed by the hardware processor 201 to the input/output device 3.

The input/output device 3 is a display device that receives various data via the interface 206 and displays the various data. In addition, the input/output device 3 receives input of various data and transmits the various data to, for example, the hardware processor 201 via the interface 206.

The input/output device 3 is, for example, a touch panel. When the input/output device 3 is a touch panel, the input/output device 3 is, for example, a capacitive touch panel. Note that the touch panel is not limited to a capacitive type, and may be a touch panel of another type. The input/output device 3 is installed on an operation panel (not illustrated) in which the numerical controller 2 is stored.

The axis control circuit 207 is a circuit that controls the servomotor 5. The axis control circuit 207 receives a control command from the hardware processor 201 and outputs various commands for driving the servomotor 5 to the servo amplifier 4. For example, the axis control circuit 207 transmits a torque command for controlling the torque of the servomotor 5 to the servo amplifier 4.

The servo amplifier 4 receives a command from the axis control circuit 207 and supplies current to the servomotor 5.

The servomotor 5 is driven by being supplied with current from the servo amplifier 4. The servomotor 5 is connected to, for example, a ball screw that drives a tool rest. By driving the servomotor 5, a structure of the machining machine 1 such as the tool rest moves in a direction of each control axis. The servomotor 5 incorporates an encoder (not illustrated) that detects a position and a feed rate of the control axis. Position feedback information and speed feedback information indicating the position of the control axis and the feed rate of the control axis detected by the encoder, respectively, are fed back to the axis control circuit 207. In this way, the axis control circuit 207 performs feedback control of the control axis.

The spindle control circuit 208 is a circuit for controlling the spindle motor 7. The spindle control circuit 208 receives a control command from the hardware processor 201 and outputs a command for driving the spindle motor 7 to the spindle amplifier 6. For example, the spindle control circuit 208 sends a spindle speed command for controlling a rotational speed of the spindle motor 7 to the spindle amplifier 6.

The spindle amplifier 6 receives a command from the spindle control circuit 208 and supplies current to the spindle motor 7.

The spindle motor 7 is driven by being supplied with current from the spindle amplifier 6. The spindle motor 7 is connected to a spindle and rotates the spindle.

The PLC 209 is a device that executes a ladder program and controls the auxiliary device 8. The PLC 209 sends a command to the auxiliary device 8 via the I/O unit 210.

The I/O unit 210 is an interface that connects the PLC 209 and the auxiliary device 8 to each other. The I/O unit 210 sends a command received from the PLC 209 to the auxiliary device 8.

The auxiliary device 8 is a device installed in the machining machine 1 to perform an auxiliary operation in the machining machine 1. The auxiliary device 8 operates based on a command received from the I/O unit 210. The auxiliary device 8 may be a device installed around the machining machine 1. The auxiliary device 8 is, for example, a tool changer, a cutting fluid injection device, or an opening/closing door drive device.

Next, functions of the machined surface estimation device will be described.

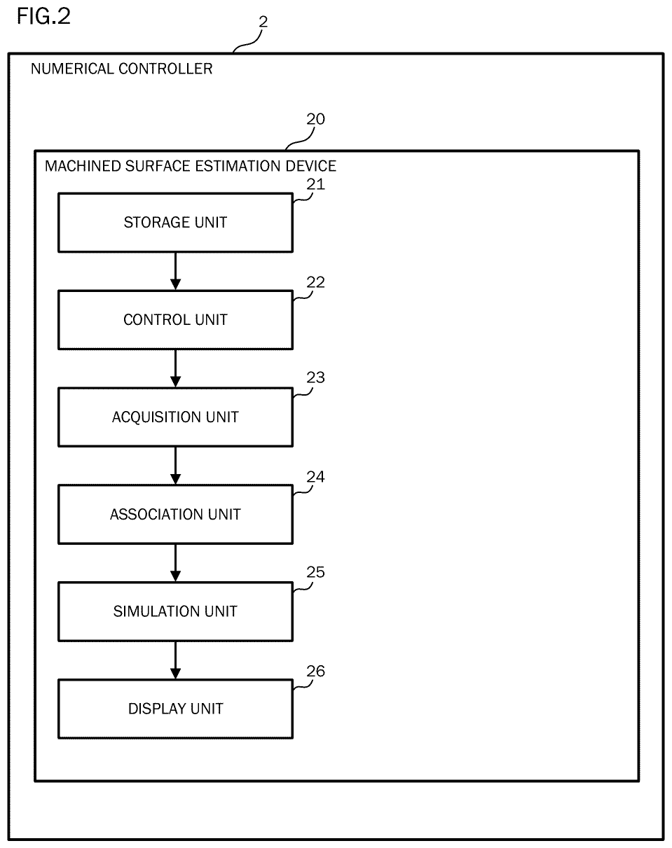

FIG. 2 is a block diagram illustrating an example of the functions of the machined surface estimation device. The machined surface estimation device 20 includes a storage unit 21, a control unit 22, an acquisition unit 23, an association unit 24, a simulation unit 25, and a display unit 26.

The storage unit 21 is realized, for example, by storing various data and various programs in the RAM 204 or the nonvolatile memory 205. For example, the control unit 22, the acquisition unit 23, the association unit 24, the simulation unit 25, and the display unit 26 are realized by the hardware processor 201 performing arithmetic processing using a system program stored in the ROM 203 and various data stored in the nonvolatile memory 205.

The storage unit 21 stores tool shape data indicating a shape of the tool and workpiece shape data indicating a shape of the workpiece. Furthermore, the storage unit 21 stores a machining program.

The tool shape data includes, for example, data indicating a tool type. The tool type includes a square end mill, a ball end mill, a milling cutter, and a cutting tool. The tool shape data may include data indicating a blade diameter, a blade length, a shank diameter, and an overall length, etc. The tool shape data may be 3D model data indicating the shape of the tool.

The workpiece shape data includes data indicating the shape of the workpiece before machining. The shape of the workpiece includes a rectangular parallelepiped shape, a columnar shape, and a cylindrical shape. Further, the workpiece shape data includes data indicating a size of the workpiece. The data indicating the size includes data indicating a length, a height, a thickness, and a depth of each side. The workpiece shape data may be 3D model data indicating the shape of the workpiece.

The control unit 22 controls one or more control axes based on a machining program. The control unit 22 controls each control axis based on a machining program stored in the storage unit 21. The one or more control axes include any of an X-axis, a Y-axis, and a Z-axis.

The acquisition unit 23 acquires tool position data indicating the position of the tool, tool shape data indicating the shape of the tool, workpiece shape data indicating the shape of the workpiece, and factor data indicating a factor that affects control of the control axis.

The tool position data is data indicating the position of the tool. The position of the tool is, for example, the position of the tip of the tool. The tool position data can also be referred to as data indicating the position of the control axis. The tool position data is, for example, feedback data from a detector that detects the position of the control axis. In this case, the acquisition unit 23 acquires tool position data from the detector that detects the position of the control axis at every predetermined sampling time. That is, the tool position data acquired by the acquisition unit 23 is time-series data. The tool position data may be command data that commands a rotational position of the servomotor 5.

The detector that detects the position of the control axis is, for example, the servomotor 5. The detector may be a linear encoder installed along each linear axis of the machining machine 1, or a rotary encoder installed around each rotation axis.

The tool position data may be data indicating coordinate values in a predetermined coordinate system converted from the feedback data. The tool position data may include data indicating any of X-axis, Y-axis, and Z-axis positions in a Cartesian coordinate system. The Cartesian coordinate system may be a machine coordinate system or a workpiece coordinate system.

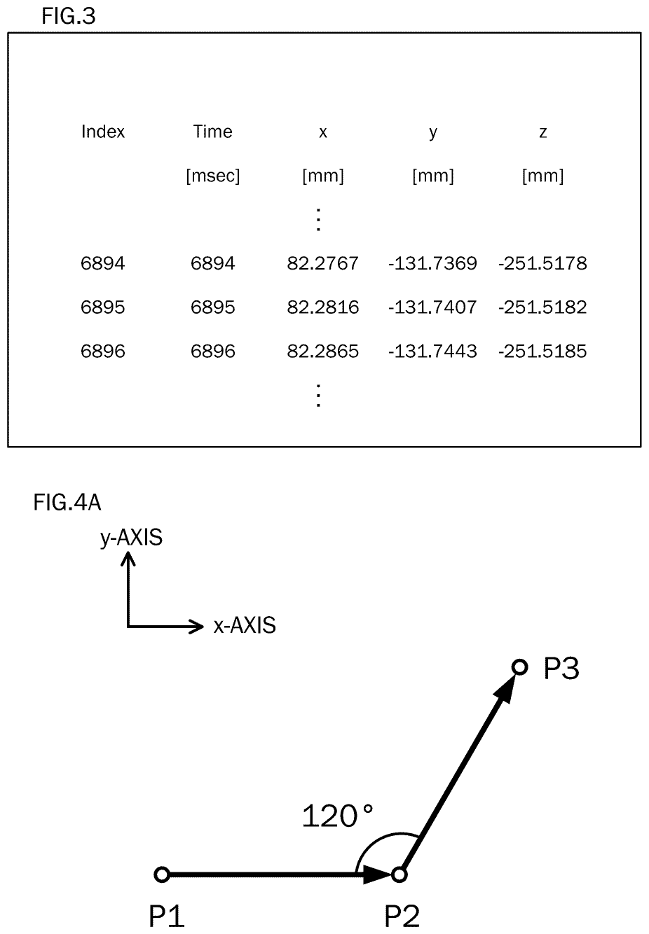

FIG. 3 is a diagram illustrating an example of the tool position data. In the example illustrated in FIG. 3, the acquisition unit 23 acquires data indicating the X-axis position, data indicating the Y-axis position, and data indicating the Z-axis position every 1 [msec].

The tool position data indicates that the tool is at a position of X82.2767 [mm], Y-131.7369 [mm], and Z-251.5178 [mm] at 6894 [msec]. Further, the tool position data indicates that the tool is in a position of X82.2816 [mm], Y-131.7407 [mm], and Z-251.5182 [mm] at 6895 [msec]. Further, the tool position data indicates that the tool is at a position of X82.2865 [mm], Y-131.7443 [mm], and Z-251.5185 [mm] at 6896 [msec]. Note that “Index” is information indicating data acquisition timing, and is information given to each tool position data.

The acquisition unit 23 acquires the tool shape data and the workpiece shape data from the storage unit 21. The acquisition unit 23 acquires, for example, a tool number designated by a tool selection command in a machining program. The acquisition unit 23 acquires tool shape data of the tool corresponding to the acquired tool number from the storage unit 21.

Furthermore, the acquisition unit 23 acquires the workpiece shape data, for example, based on information designating the workpiece input from the input/output device 3. The acquisition unit 23 may acquire a workpiece number that designates a workpiece designated in the machining program. In this case, the acquisition unit 23 acquires the workpiece shape data of the workpiece corresponding to the acquired workpiece number from the storage unit 21.

The factor data indicating the factor that affects control of the control axis is data indicating the factor that affects control of the control axis by the control unit 22 when the machining program is executed. For example, affecting means changing control based on a command designated by the machining program. By changing the control, either machining quality of the workpiece or a machining time of the workpiece is affected. Therefore, data indicating the factor that affects control of the control axis can be considered as data related to a factor affecting either the machining quality of the workpiece or the machining time of the workpiece. The machining quality is a concept that includes machining accuracy of the workpiece, surface roughness of the machined surface, and gloss of the machined surface.

In addition, the factor data indicating the factor that affects control of the control axis is parameter setting data that indicates a setting state of a control parameter or control signal data that indicates a state of a control signal. Alternatively, when control of the control axis is affected, the factor data is data indicating which factor causes the affection. The acquisition unit 23 acquires the factor data only when control of the control axis is affected.

The factor data indicating the factor that affects control of the control axis includes any of acceleration/deceleration factor data indicating an acceleration/deceleration factor, stop factor data indicating a stop factor, parameter change data indicating change of a parameter, and path correction data indicating correction of a machining path.

The acceleration/deceleration factor data is data related to a factor that affects the feed rate of the control axis. For example, affecting the feed rate means affecting control based on a feed rate designated by a machining program.

The acceleration/deceleration factor data includes deceleration factor data indicating a deceleration factor that decelerates the control axis. The deceleration factor data includes any of allowable acceleration data, allowable jerk data, and allowable speed difference data.

The allowable acceleration data is data indicating maximum acceleration of the control axis that is allowed. The allowable acceleration data may be data indicating the maximum acceleration allowed when the control axis is controlled by cutting feed. When the factor data is the allowable acceleration data, the control unit 22 controls the control axis so as not to exceed the allowable acceleration. For example, when the acceleration of the control axis is estimated to exceed the allowable acceleration if the control axis is controlled based on a command designated by a machining program, the control unit 22 controls the control axis at the allowable acceleration on a movement path where the acceleration is estimated to exceed the allowable acceleration.

The allowable jerk data is data indicating maximum jerk of the control axis that is allowed. The allowable jerk data may be data indicating the maximum jerk when the control axis is controlled by the cutting feed. When the factor data is the allowable jerk data, the control unit 22 controls the control axis so that the allowable jerk is not exceeded.

The allowable speed difference data is data on an allowable speed difference of the tool that occurs in each control axis direction at a position that discontinuously changes when a moving direction of the tool discontinuously changes. The position that discontinuously changes is a position where a tangent to a movement trajectory of the tool is discontinuous. The position that discontinuously changes is referred to as a discontinuous change point.

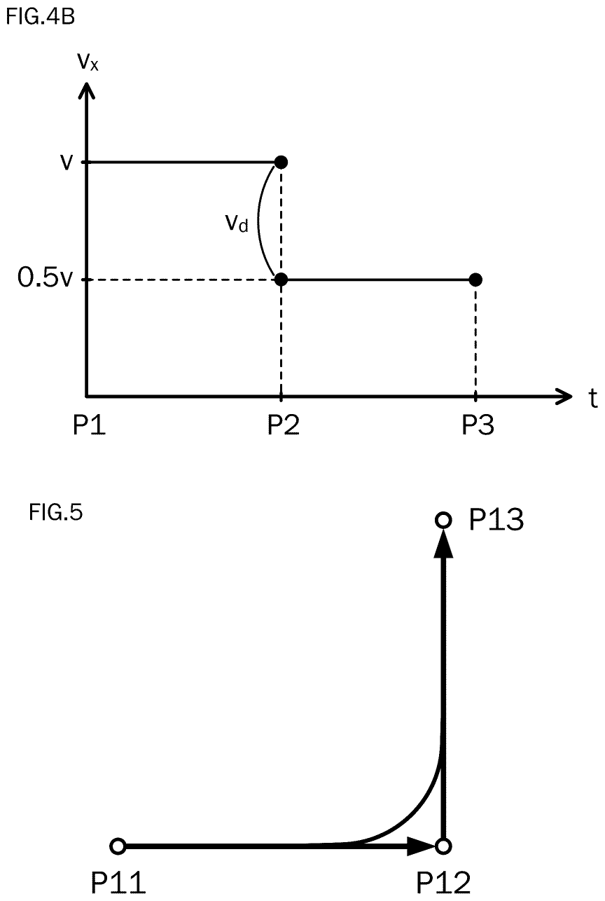

FIG. 4A and FIG. 4B are diagrams for describing a speed difference. FIG. 4A illustrates a movement path of the tool when the tool is moved from position P1 to position P2 and the tool is further moved from position P2 to position P3 without stopping the tool at position P2. The moving direction of the tool discontinuously changes at P2. That is, P2 is a discontinuous change point.

When moved on the movement path illustrated in FIG. 4A without changing a feed rate of the tool, a feed rate Vx of the tool in an X-axis direction is as illustrated in FIG. 4B. In other words, the tool moves at a feed rate of V from P1 to P2, and moves at a feed rate of 0.5 V from P2 to P3. The feed rate of the tool changes from V to 0.5 V at position P2. The amount of change in this feed rate is a speed difference Vd.

When the factor data is allowable speed difference data, the control unit 22 controls the control axis so as not to exceed the allowable speed difference.

The above-mentioned allowable acceleration data, allowable jerk data, and allowable speed difference data are set as control parameters. In other words, the acceleration/deceleration factor data can be considered to be parameter setting data indicating setting states of the control parameters.

The stop factor data is data related to a factor that sets the feed rate of the control axis to 0 [mm/min]. The stop factor data includes data indicating whether the in-position check is on or off, data indicating override 0%, data indicating a speed attainment signal waiting state, and data indicating a dwelling state.

The in-position check is to check whether or not the tool has entered an area referred to as an in-position.

FIG. 5 is a diagram for describing the in-position check. When a corner connecting position P11, position P12, and position P13 in order is machined by the tool, the tool generally starts moving toward position P13 before reaching position P12. Therefore, the corner is machined into a shape illustrated as a curve.

On the other hand, when position P12 is set as an in-position, after confirming that the tool has reached the in-position, that is, position P12, the tool moves toward P13. That is, after movement in a direction from P11 to P12 stops, the tool moves from P12 to P13. In this way, the corner is machined into a shape formed by intersection of two straight lines rather than a curve.

The data indicating override 0% is data generated when an override setting switch provided on the operation panel or a control parameter is set to override 0%. When the feed rate is set to override 0%, movement of a feed axis stops.

Data indicating the speed attainment signal waiting state is data indicating a state in which movement of the control axis is stopped until a signal indicating that the rotational speed of the spindle has reached a predetermined speed is output. The data indicating the speed attainment signal waiting state may be data indicating a state in which, until a signal indicating that a feed rate of one control axis has reached a predetermined speed is output, movement of another control axis is stopped.

Data indicating the dwelling state is data indicating a state in which progress of a machining program is stopped for a time designated during automatic operation.

Each of the data indicating whether the in-position check is on or off, the data indicating override 0%, the data indicating the speed attainment signal waiting state, and the data indicating the dwelling state is data indicating a state of a control signal of the numerical controller 2. In other words, each of these pieces of data can be considered to be control signal data indicating the state of the control signal.

The parameter change data is data related to change of a control parameter. For example, when the numerical controller 2 has a function of changing a machining condition during execution of the machining program, the numerical controller 2 can change the machining condition during execution of the machining program. In this case, the parameter change data is data indicating that the machining condition has been changed.

The path correction data is data related to correction of the movement path of the tool. Correction of the movement path means, for example, correcting the commanded path according to a machining shape or a machining condition. The path correction data includes data indicating whether a nano-smoothing function is on or off, and data indicating whether a smooth tolerance function is on or off.

The nano-smoothing function is a function that smooths a movement path of the tool, which is generated based on a machining program and is formed by interconnecting minute line segments.

The smooth tolerance function is a function that smooths the movement path of the tool within a predetermined tolerance range.

Each of the data indicating whether the nano-smoothing function is on or off and the data indicating whether the smooth tolerance function is on or off is data indicating a state of a control signal. In other words, each of these pieces of data is control signal data indicating the state of the control signal.

The acquisition unit 23 acquires factor data at every predetermined sampling time. That is, the factor data acquired by the acquisition unit 23 is time-series data.

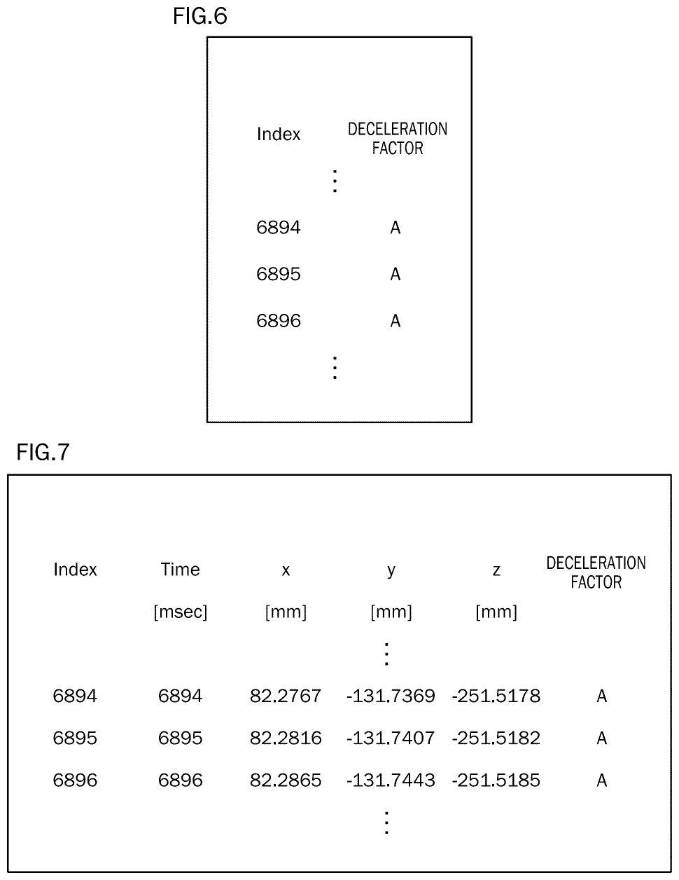

FIG. 6 is a diagram illustrating an example of the factor data acquired by the acquisition unit 23. The factor data illustrated in FIG. 6 is deceleration factor data indicating a deceleration factor A. The deceleration factor A is, for example, allowable acceleration. That is, at the timing when the acquisition unit 23 acquires the deceleration factor A, deceleration control is performed on each control axis so as not to exceed the allowable acceleration. The acquisition unit 23 acquires the factor data along with “Index” indicating the timing of acquiring the factor data.

The association unit 24 associates tool position data with factor data. The association unit 24 associates the tool position data with the factor data, for example, based on Index given to the tool position data and Index given to the factor data.

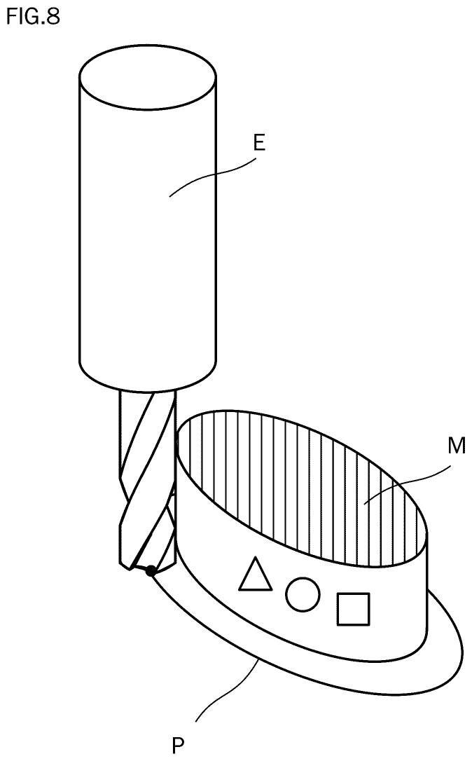

FIG. 7 is a diagram illustrating the tool position data and the factor data associated by the association unit 24. As described above, Index is information indicating the data acquisition timing. Therefore, the tool position data and the factor data associated by the association unit 24 are data acquired at the same timing. For example, tool position data X82.2767, Y-131.7369, and Z-251.5178 illustrated in a row with Index 6894 and factor data indicating the deceleration factor A are information acquired at the same timing.

The simulation unit 25 generates a machining model based on the tool position data, the tool shape data, and the workpiece shape data acquired by the acquisition unit 23. The machining model is, for example, a 3D model of a machined workpiece.

The display unit 26 displays factor information indicating the factor data on the machining model generated by the simulation unit 25 based on the tool position data and the factor data associated by the association unit 24. The factor information is displayed using, for example, a figure, a character, and a color.

The display unit 26 displays factor information on the machined surface of the workpiece that is being cut by the tool at a position indicated by the tool position data. The display unit 26 displays the machining model on which the factor information is drawn on a display screen of the input/output device 3.

FIG. 8 is a diagram for describing display of the factor information. A machining model M indicates a workpiece whose side surface has been machined by a cutting blade on a side surface of an end mill E. In this case, a movement path P of the tip of the tool is present at a different position from the machined surface. In other words, a position indicated by the tool position data and a cutting position cut by the tool at the position indicated by the tool position data do not necessarily match.

The display unit 26 displays the factor information on the machining model M using the tool position data and the factor data associated by the association unit 24, as well as the tool shape data and the workpiece shape data. The display unit 26 obtains a position of the workpiece surface being cut when the tip of the tool passes through the position indicated by the tool position data based on the tool position data, the tool shape data, and the workpiece shape data. That is, the display unit 26 specifies a display position of the factor information to be displayed on the machining model M. The display unit 26 causes factor information indicating factor data associated with this display position to be displayed at the obtained display position on the workpiece surface. The factor information is displayed using, for example, a figure representing a triangle, a figure representing a circle, and a figure representing a square.

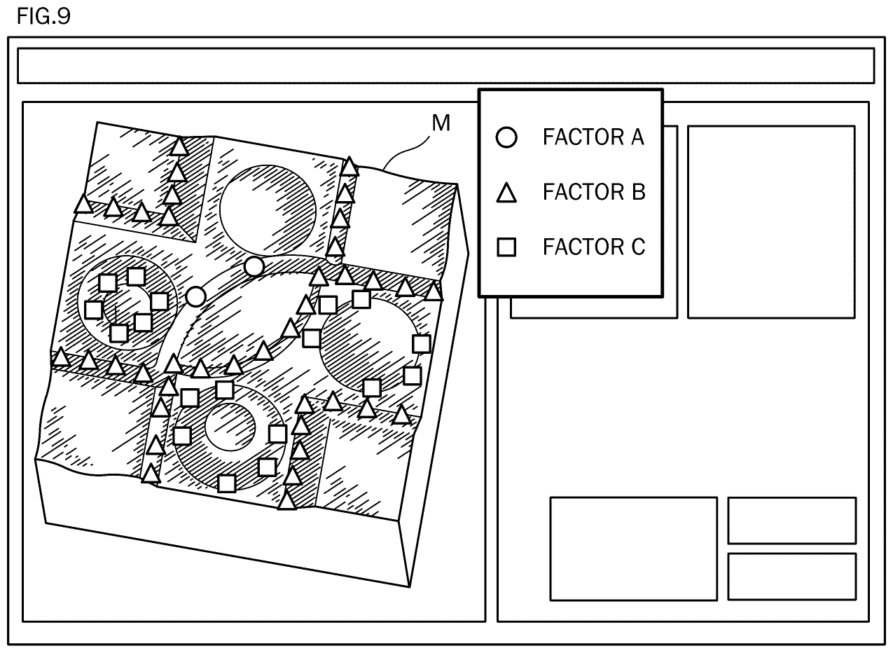

FIG. 9 is a diagram illustrating a specific example of factor information displayed on the machining model M. In FIG. 9, factor information indicating a factor A, factor information indicating a factor B, and factor information indicating a factor C are displayed.

For example, the factor A is override 0%. In this case, the override is set to 0% at a position where a figure representing a circle is displayed.

For example, the factor B is an on state of the nano-smoothing function. In this case, at a position where a figure representing a triangle is displayed, the control axis is controlled while the nano-smoothing function is turned on.

For example, the factor C is allowable acceleration. In this case, at a position where a figure representing a square is displayed, deceleration control is performed on the feed rate of the tool so as not to exceed the allowable acceleration.

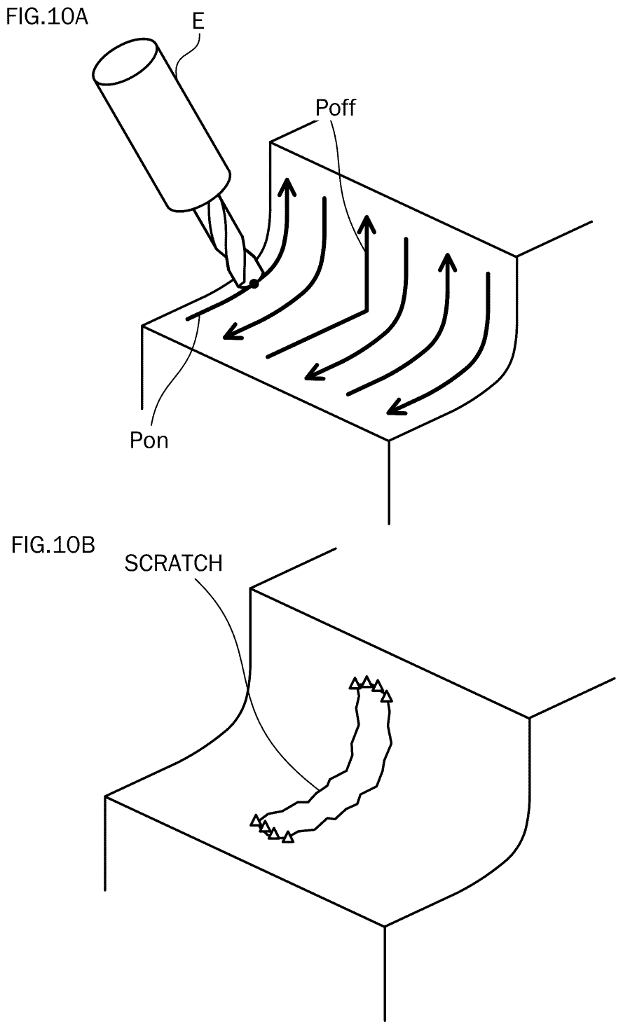

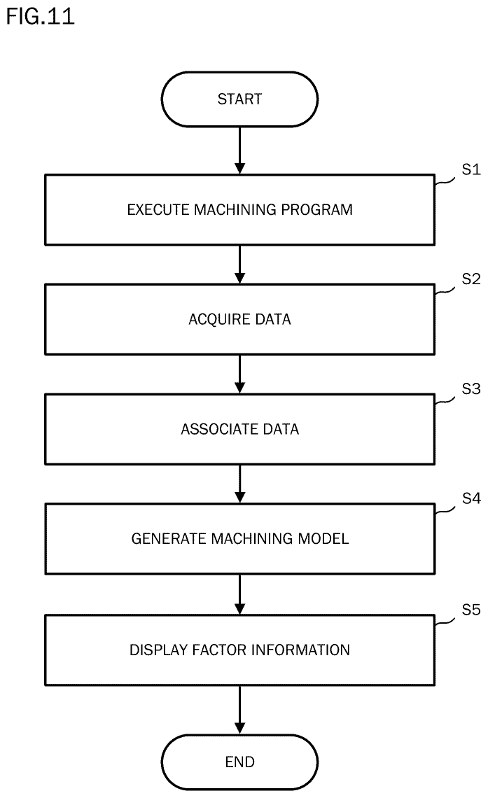

FIG. 10A and FIG. 10B are diagrams for describing display of the path correction data. A curved arrow of FIG. 10A indicates a movement path Pon when the tool is cutting-fed while the smooth tolerance function is turned on. Further, an arrow formed by intersecting straight lines indicates a movement path Poff when the tool is cutting-fed while the smooth tolerance function is turned off.

FIG. 10B illustrates that factor information is displayed at a position where the tool is cutting-fed while the smooth tolerance function is turned off. By checking this display, the operator can estimate that a factor of a scratch formed on the workpiece is that the smooth tolerance function is turned off.

Next, processing executed by the machined surface estimation device 20 will be described.

FIG. 11 is a flowchart illustrating an example of processing executed by the machined surface estimation device 20. First, the control unit 22 executes a machining program (step S1). In other words, the control unit 22 controls each control axis based on the machining program.

Next, the acquisition unit 23 acquires data (step S2). The acquisition unit 23 acquires data during execution of the machining program. The data acquired by the acquisition unit 23 is the tool position data, the tool shape data, the workpiece shape data, and the factor data.

Next, the association unit 24 associates the data (step S3). The association unit 24 associates the tool position data with the factor data.

Next, the simulation unit 25 generates the machining model M (step S4). The simulation unit 25 generates the machining model M based on the tool position data, the tool shape data, and the workpiece shape data.

Next, the display unit 26 displays the factor information on the machining model M (step S5), and the processing ends.

As described above, the machined surface estimation device 20 includes the acquisition unit 23 that acquires the tool position data indicating the position of the tool, the tool shape data indicating the shape of the tool, the workpiece shape data indicating the shape of the workpiece, and the factor data indicating the factor that affects control of the control axis, the association unit 24 that associates the tool position data and the factor data, the simulation unit 25 that generates the machining model M based on the tool position data, the tool shape data, and the workpiece shape data acquired by the acquisition unit 23, and the display unit 26 that displays the factor information indicating the factor data on the machining model M generated by the simulation unit 25 based on the tool position data and the factor data associated by the association unit 24.

Therefore, the machined surface estimation device 20 can allow the operator to easily estimate which position on the machined surface is being machined when the factor that affects control of the control axis has occurred. In this way, the operator can efficiently investigate an effect of the factor that affects control of the control axis on the machined surface.

Further, the factor data is data related to a factor that affects either the machining quality of the workpiece or the machining time of the workpiece. Specifically, the factor data includes any of acceleration/deceleration factor data indicating an acceleration/deceleration factor, stop factor data indicating a stop factor, parameter change data indicating parameter change, and path correction data indicating correction of the machining path.

Therefore, the machined surface estimation device 20 can allow the operator to easily estimate which factor will occur during machining among the factors indicated by these various factor data.

Furthermore, the display unit 26 specifies a display position of factor information to be displayed on the machining model M based on the tool position data, the tool shape data, and the workpiece shape data, and displays the factor information at the display position. Therefore, the factor information can be displayed on the machined surface that is being machined when factor data is acquired.

The machined surface estimation device 20 further includes a reception unit that receives display mode information defining a display mode of factor information, and the display unit 26 may display the factor information based on the display mode information received by the reception unit.

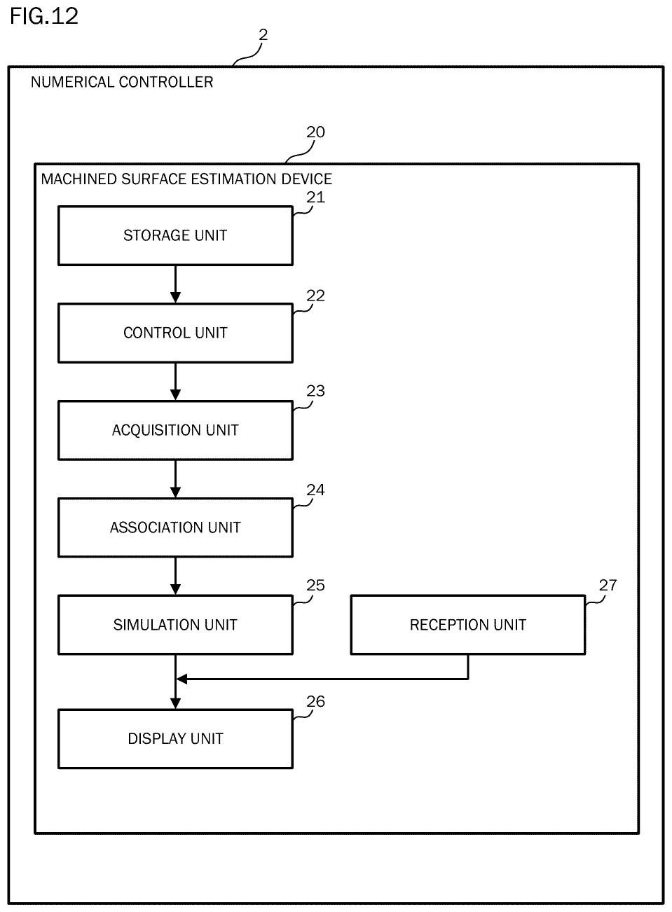

FIG. 12 is a block diagram illustrating an example of functions of the machined surface estimation device 20 including the reception unit. Note that, hereinafter, functions different from the functions of the machined surface estimation device 20 illustrated in FIG. 2 will be described, and descriptions of the same functions will be omitted.

The reception unit 27 receives display mode information defining a display mode of factor information. For example, the display unit 26 may display options for the display mode of the factor information on the display screen, and the reception unit 27 may receive selection of any of the options. The options for the display mode are, for example, the figure representing the circle, the figure representing the triangle, and the figure representing the square illustrated in FIG. 9.

The display unit 26 displays the factor information on the display screen based on the display mode information received by the reception unit 27. For example, the reception unit 27 receives display mode information of a figure representing a circle as a display mode of the factor A, display mode information of a figure representing a triangle as a display mode of the factor B, and display mode information of a figure representing a square as a display mode of the factor C. In this case, the display unit 26 displays factor information indicating the factor A, the factor B, and the factor C in the display mode illustrated in FIG. 9.

In addition, the factor information may be a figure having directionality. The figure having directionality is a figure that can indicate at least one of direction and size.

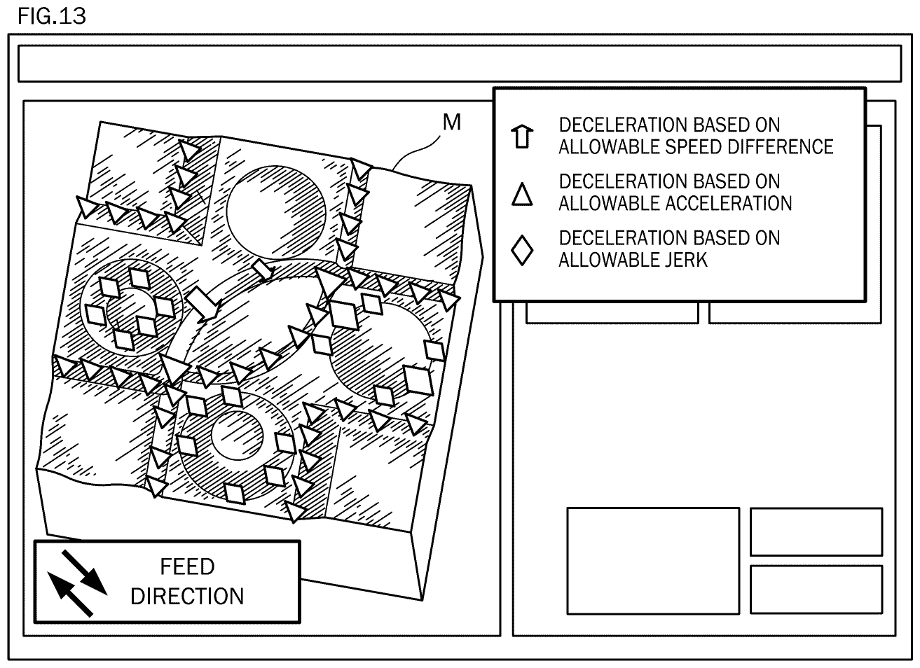

FIG. 13 is a diagram illustrating an example of the display mode of the factor information. The figure having directionality includes a figure indicating a feed direction of the tool and duration of a factor. Examples of the figure having directionality include figures of an arrow, an isosceles triangle, and a rhombus. In addition, the figure having directionality indicates duration of a factor by a length in a direction indicated by the figure.

When the factor information is the arrow, the direction of the arrow is the feed direction of the tool. In addition, the length of the arrow indicates the duration of the factor. In the example illustrated in FIG. 13, the arrow indicates the feed direction of the tool and a time during which deceleration is controlled based on the allowable speed difference.

When the factor information is the isosceles triangle, a direction pointed by a vertical angle is the feed direction of the tool. Further, a height of the isosceles triangle indicates the duration of the factor. In the example illustrated in FIG. 13, the isosceles triangle indicates the feed direction of the tool and a time during which deceleration is controlled based on the allowable acceleration.

When the factor information is the rhombus, a direction in which a longer diagonal of two diagonals is directed is the feed direction of the tool. In addition, a length of the longer diagonal of the two diagonals indicates the duration of the factor. In the example illustrated in FIG. 13, the rhombus indicates the feed direction of the tool and a time during which deceleration is controlled based on the allowable jerk.

The machined surface estimation device 20 may further include a machining information calculation unit that calculates machining information including at least one of speed, acceleration, and jerk of the tool, and path error information, and a machining information selection unit that selects at least one piece of information included in the machining information calculated by the machining information calculation unit.

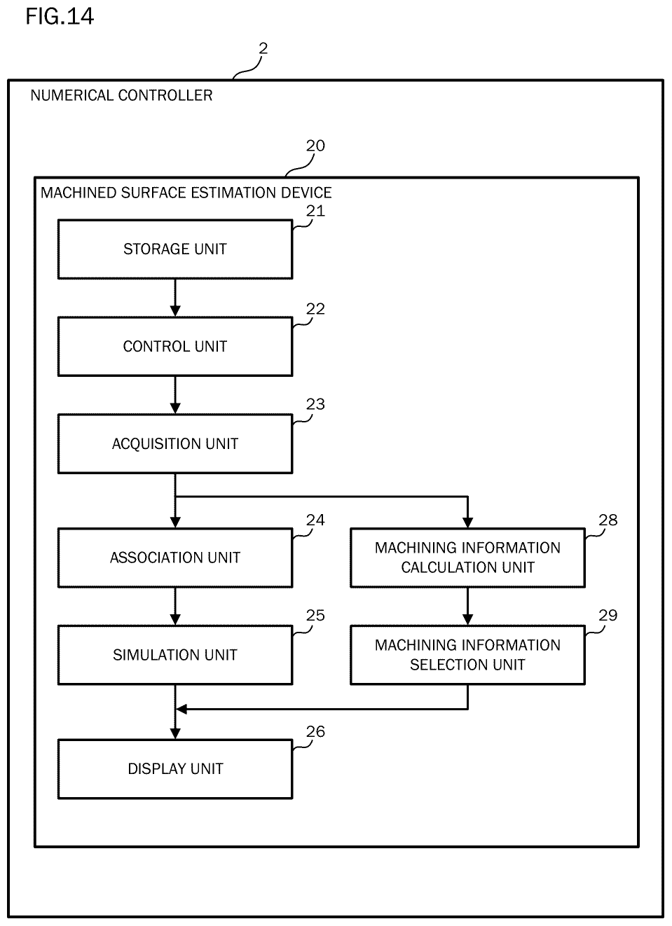

FIG. 14 is a block diagram illustrating an example of functions of the machined surface estimation device 20 including the machining information calculation unit and the machining information selection unit.

The machined surface estimation device 20 includes the machining information calculation unit 28 and the machining information selection unit 29 in addition to the functions illustrated in FIG. 2. Note that, hereinafter, functions different from the functions of the machined surface estimation device 20 illustrated in FIG. 2 will be described, and descriptions of the same functions will be omitted.

The machining information calculation unit 28 calculates machining information including at least one of speed, acceleration, and jerk of the tool, and path error information. The machining information calculation unit 28 calculates information on the speed, the acceleration, and the jerk of the tool based on the tool position data acquired by the acquisition unit 23 and time information of an RTC (real-time clock) incorporated in the machined surface estimation device 20. Furthermore, the machining information calculation unit 28 calculates path error information based on the movement path P of the tool designated by the machining program and the tool position data acquired by the acquisition unit 23.

The machining information selection unit 29 selects at least one piece of information included in the machining information calculated by the machining information calculation unit 28. For example, the machining information selection unit 29 may select any information based on information set in advance as a parameter. The machining information selection unit 29 may select any information based on a selection operation of the operator.

The display unit 26 displays at least any information selected by the machining information selection unit 29 on the machining model M.

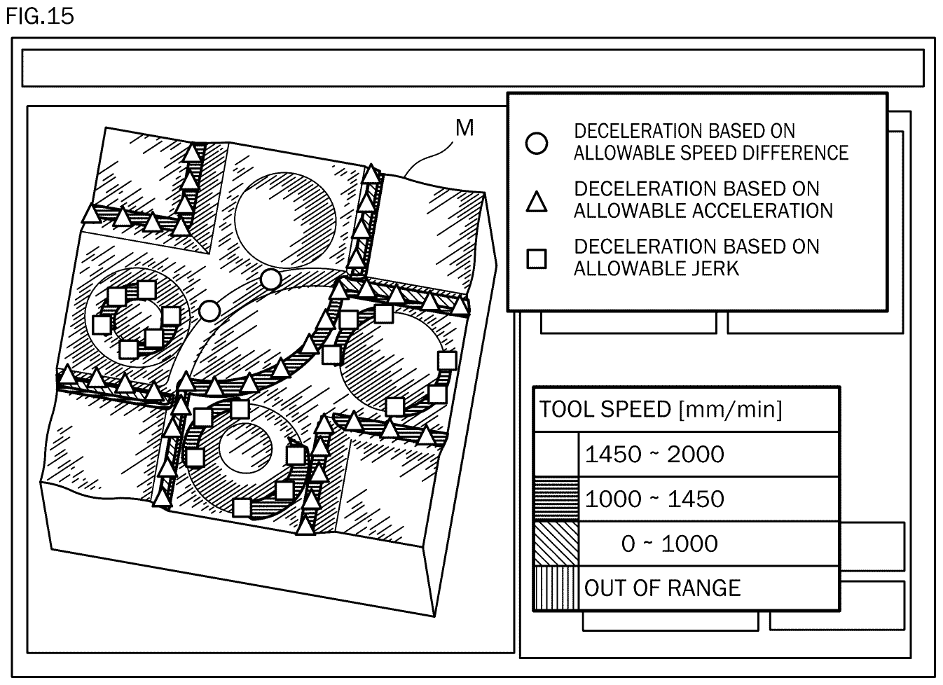

FIG. 15 is a diagram illustrating an example of machining information displayed on the machining model M. The machining information illustrated in FIG. 15 is information indicating a speed of the tool. The display unit 26 displays factor information indicating three factors on the machining model M. The three factors are a deceleration factor based on the allowable speed difference, a deceleration factor based on the allowable acceleration, and a deceleration factor based on the allowable jerk, respectively.

The display unit 26 further displays machining information on the machining model M. Here, the machining information is information on the feed rate of the tool. For example, the display unit 26 paints a surface of the machining model M using a different color for each feed rate. For example, the display unit 26 paints a region in which the feed rate is controlled within a range of 1450 to 2000 [mm/min] green. In addition, the display unit 26 paints a region in which the feed rate is controlled within a range of 1000 to 1450 [mm/min] blue. In addition, the display unit 26 paints a region in which the feed rate is controlled within a range of 0 to 1000 [mm/min] red. In addition, the display unit 26 does not color a region in which a control operation is performed so that the feed rate is not included in these ranges.

In this way, the machined surface estimation device 20 can display the machining information along with the factor information. Furthermore, the machined surface estimation device 20 can display the surface of the machining model M in a different color for each feed rate. For this reason, the machined surface estimation device 20 can allow the operator to efficiently estimate influences of the factor that affects control of the control axis, the actual feed rate of the tool, etc. on the machined surface of the workpiece.

Note that the disclosure is not limited to the embodiment described above, and can be modified as appropriate without departing from the outline. In the disclosure, it is possible to modify any component of the embodiment or omit any component of the embodiment.

### EXPLANATIONS OF LETTERS OR NUMERALS

1 MACHINING MACHINE
2 NUMERICAL CONTROLLER
20 MACHINED SURFACE ESTIMATION DEVICE
21 STORAGE UNIT
22 CONTROL UNIT
23 ACQUISITION UNIT
24 ASSOCIATION UNIT
25 SIMULATION UNIT
26 DISPLAY UNIT
27 RECEPTION UNIT
28 MACHINING INFORMATION CALCULATION UNIT
29 MACHINING INFORMATION SELECTION UNIT
201 HARDWARE PROCESSOR
202 BUS
203 ROM
204 RAM
205 NONVOLATILE MEMORY
206 INTERFACE
207 AXIS CONTROL CIRCUIT
208 SPINDLE CONTROL CIRCUIT
209 PLC
210 I/O UNIT
3 INPUT/OUTPUT DEVICE
4 SERVO AMPLIFIER
5 SERVOMOTOR
6 SPINDLE AMPLIFIER
7 SPINDLE MOTOR
8 AUXILIARY DEVICE
M MACHINING MODEL
E END MILL
P MOVEMENT PATH

1. A machined surface estimation device comprising:
an acquisition unit configured to acquire tool position data indicating a position of a tool, tool shape data indicating a shape of the tool, workpiece shape data indicating a shape of a workpiece, and factor data indicating a factor affecting control of a control axis;
an association unit configured to associate the tool position data with the factor data;
a simulation unit configured to generate a machining model based on the tool position data, the tool shape data, and the workpiece shape data acquired by the acquisition unit; and
a display unit configured to display factor information indicating the factor data on the machining model generated by the simulation unit based on the tool position data and the factor data associated by the association unit.

2. The machined surface estimation device according to claim 1, further comprising a reception unit configured to receive display mode information defining a display mode of the factor information,
wherein the display unit displays the factor information based on the display mode information received by the reception unit.

3. The machined surface estimation device according to claim 1 or 2, wherein the factor information is a figure having directionality.

4. The machined surface estimation device according to any one of claims 1 to 3, wherein the factor data is data related to a factor affecting either machining quality of the workpiece or a machining time of the workpiece.

1. A machined surface estimation device comprising:
an acquisition unit configured to acquire tool position data indicating a position of a tool, tool shape data indicating a shape of the tool, workpiece shape data indicating a shape of a workpiece, and factor data indicating a factor affecting control of a control axis;
an association unit configured to associate the tool position data with the factor data;
a simulation unit configured to generate a machining model based on the tool position data, the tool shape data, and the workpiece shape data acquired by the acquisition unit; and
a display unit configured to display factor information indicating the factor data on the machining model generated by the simulation unit based on the tool position data and the factor data associated by the association unit.

2. The machined surface estimation device according to claim 1, further comprising a reception unit configured to receive display mode information defining a display mode of the factor information,
wherein the display unit displays the factor information based on the display mode information received by the reception unit.

3. The machined surface estimation device according to claim 1 or 2, wherein the factor information is a figure having directionality.

4. The machined surface estimation device according to any one of claims 1 to 3, wherein the factor data is data related to a factor affecting either machining quality of the workpiece or a machining time of the workpiece.

5. The machined surface estimation device according to any one of claims 1 to 4, wherein the factor data includes any of acceleration/deceleration factor data indicating an acceleration/deceleration factor, stop factor data indicating a stop factor, parameter change data indicating change of a parameter, and path correction data indicating correction of a machining path.

6. The machined surface estimation device according to any one of claims 1 to 5, further comprising:
a machining information calculation unit configured to calculate machining information including information on at least one of speed, acceleration, and jerk of the tool and a path error; and
a machining information selection unit configured to select at least one piece of the information included in the machining information calculated by the machining information calculation unit,
wherein the display unit displays the at least one piece of the information selected by the machining information selection unit on the machining model.

7. The machined surface estimation device according to any one of claims 1 to 6, wherein the display unit specifies a display position of the factor information to be displayed on the machining model based on the tool position data, the tool shape data, and the workpiece shape data, and displays the factor information at the display position.

8. A computer-readable storage medium configured to store instructions causing a computer to execute:
acquiring tool position data indicating a position of a tool, tool shape data indicating a shape of the tool, workpiece shape data indicating a shape of a workpiece, and factor data indicating a factor affecting control of a control axis;
associating the tool position data with the factor data;
generating a machining model based on the tool position data, the tool shape data, and the workpiece shape data acquired; and
displaying factor information indicating the factor data on the generated machining model based on the tool position data and the factor data associated with each other.
